(19) United States
(12) Patent Application Publication
(10) Pub. No.: US 2009/0113678 A1
(43) Pub. Date: May 7, 2009

(54) CATCH BASE FOR ATTACHING CATCH OF SNAP FASTENER

(76) Inventor: Keiyou SHIMIZU, (US)

Correspondence Address: MCGLEW & TUTTLE, PC, P.O. BOX 9227, SCARBOROUGH STATION, SCARBOROUGH, NY, 10510-9227, US

(21) Appl. No.: 12/128,032

(22) Filed: May 28, 2008

(30) Foreign Application Priority Data
Nov. 2, 2007 (JP) 2007-8470 U

(51) Int. Cl. A44B 17/00; F16B 21/07; B21D 28/24

(52) U.S. Cl. 24/662; 24/691; 83/30

(57) ABSTRACT

To provide a catch base capable of firmly attaching a catch of a snap fastener to a cloth. The catch base includes six claws for attaching the catch formed at regular intervals. The catch is put on one side of the cloth, and the claws are fitted into catching portions formed at the backside of the catch from the other side of the cloth. The catch base and the catch are then swaged together. With this, the strength in attaching the catch is increased by 20% due to the effect of the six claws, and the catch is not removed during the use, resulting in an improved safety.

### CROSS REFERENCE TO RELATED APPLICATIONS

This application claims the benefit of priority under 35 U.S.C. § 119 of Japanese Patent Application JP 2007-8470 U filed Nov. 2, 2007, the entire contents of which are incorporated herein by reference.

### FIELD OF THE INVENTION

The present invention relates to snap fasteners used for joining seams of, for example, clothes. More specifically, it relates to catch bases for attaching catches of snap fasteners with improved safety achieved by increasing the number of claws of the catch bases used for attaching the catches of the snap fasteners to clothes from five, as in known technologies, to six such that the strength in attaching the catches is increased by approximately 20%.

### BACKGROUND OF THE INVENTION

A catch base is used for attaching a catch of a snap fastener to a cloth (fabric). The catch is put on one side of the cloth, and claws of the catch base are fitted into catching portions formed at the backside of the catch from the other side of the cloth. The catch base is then pressed into contact with the catch while the cloth is interposed therebetween. With this, the ends of the claws are bent outward inside the catching portions, and the catch base and the catch are swaged together. As shown in FIG. 4, a known catch base 1′ includes a body 2′ and five claws 3a′ to 3e′ formed at regular intervals in a central portion of the body 2′ by punching. As shown in FIG. 5, the five claws 3a′ to 3e′ are raised by 90°. This structure causes the following problems:

1. The catch may be accidentally removed from the claws 3a′ to 3e′ of the catch base due to insufficient strength of the five claws 3a′ to 3e′ during repeated use. In the case of baby clothes, for example, there is a danger that infants may put the removed catch in their mouth.

2. When the strength in attaching the catch is increased by increasing the thickness of the claws of the catch base (thickness of the material) so that the catch is not removed, the cost of the material is increased. In addition, loads of pressing and raising the claws are increased, resulting in an increase in production cost.

3. When the thickness of the material is increased, the weight is increased correspondingly. This can be a negative factor for products required to be ultra-lightweight.

4. When the weight of the catch base is increased, thin or weak cloth may be worn in a short period of time correspondingly.

The catch base having the above-described structure is described in Japanese Unexamined Utility Model (Registration) Application Publication No. 6-37707 as a component with reference number 7, and the claws 3a′ to 3e′ correspond to components with reference number 8.

### SUMMARY OF THE INVENTION

An object of the present invention is to provide a catch base for attaching a catch of a snap fastener having increased strength in attaching the catch without increasing the thickness of the material (thickness of the catch base).

To accomplish the object, the number of claws, disposed at regular intervals, of a catch base according to an aspect of the present invention is increased from five to six. With this, the strength can be increased by approximately 20%, and it is not necessary to increase the thickness of the material (thickness of the catch base).

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiment of the invention is illustrated.

### BRIEF DESCRIPTION OF THE DRAWINGS

In the drawings:

FIG. 1 is a plan view of a catch base according to an embodiment of the present invention before claws thereof are raised;

FIG. 2 is a cross-sectional view taken along line A-A′ in FIG. 1, illustrating the catch base according to the embodiment of the present invention after the claws thereof are raised by 90′;

FIG. 3 is a sectional view of a catch attached to a cloth using the catch base according to the embodiment of the present invention;

FIG. 4 is a plan view of a known catch base having five claws;

FIG. 5 is a cross-sectional view taken along line B-B′ in FIG. 4, illustrating the catch base after the five claws thereof are raised.

### DESCRIPTION OF THE PREFERRED EMBODIMENTS

A catch base according to an embodiment of the present invention includes a flat metallic disk and six claws. The claws are formed at regular intervals in a central portion of the disk by punching such that the ends of the claws face the center of the disk, and are raised by 90° after punching. The strength of this catch base (the material, the thickness, and the size of the metallic disk) can be set depending on its use. Moreover, the catch base can be plated or coated if required.

### First Embodiment

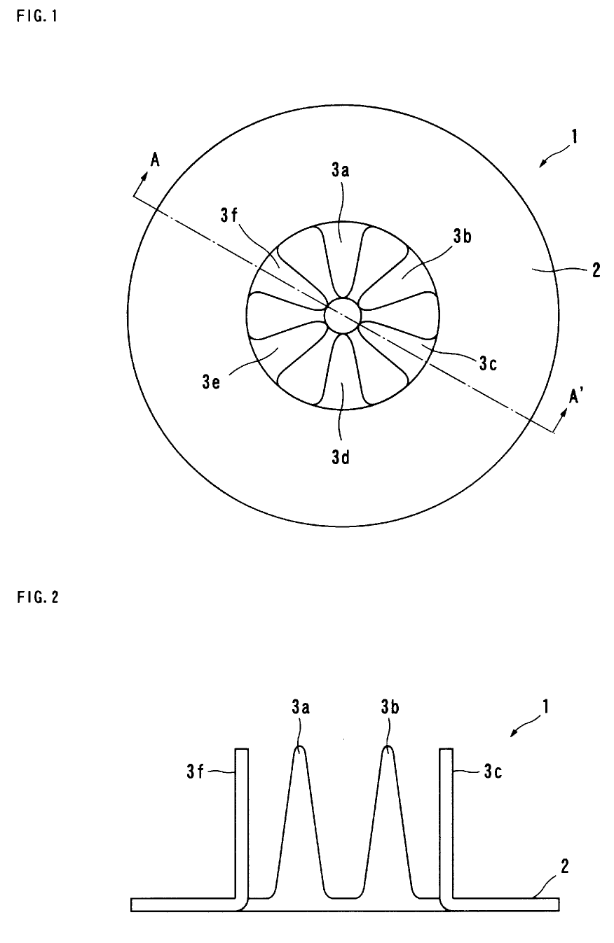

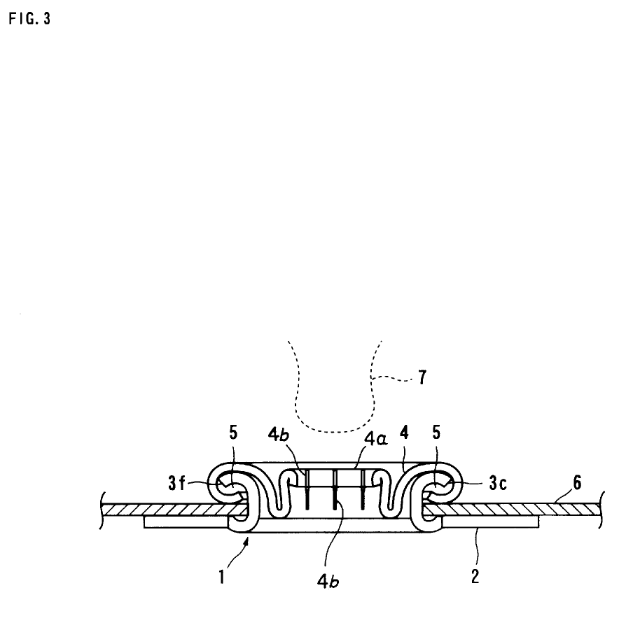

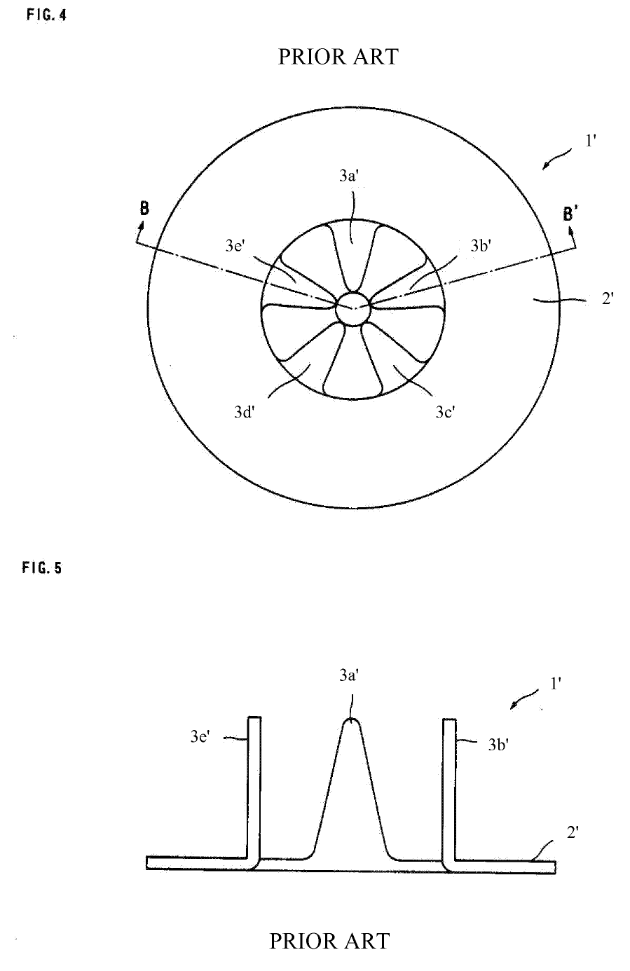

A catch base according to an embodiment of the present invention will now be described in detail with reference to FIGS. 1 to 3. FIG. 1 is a plan view of a metallic disk having claws formed by punching using a press. FIG. 2 is a side view of the catch base whose claws are raised by 90°. FIG. 3 illustrates a catch attached to a cloth using the catch base according to the embodiment of the present invention. In FIGS. 1 to 3, a catch base 1 includes a body 2 and six claws 3a to 3f formed by punching such that ends of the claws 3a to 3f face the center of the body 2. In order to use the catch base 1 as a product, the claws 3a to 3f are raised by 90° as shown in FIG. 2.

As shown in FIG. 3, a catch 4 is put on one side of a cloth 6, and the claws 3a to 3f of the catch base 1 having the above-described structure are fitted into catching portions 5 of the catch 4 from the other side of the cloth 6.

The catch base 1 is then pressed into contact with the catch 4 while the cloth 6 is interposed therebetween using a swaging tool. With this, the ends of the claws 3a to 3f are bent outward inside the catching portions 5 of the catch 4, and the claws 3a to 3f are engaged with the catch 4.

As shown in FIG. 3, a projection 7 is engaged with a ring-shaped portion 4a formed in a central portion of the catch 4. Gaps 4b are formed at predetermined positions of the ring-shaped portion 4a so that the projection 7 is easily engaged with and not easily removed from the catch 4 by the elastic effect caused by the gaps 4b.

The catch base according to the embodiment of the present invention having six claws as described above can produce the following effects:

1. The catch will not accidentally removed from the catch base during repeated use since the strength in attaching the catch is increased by the six claws. Thus, in the case of baby clothes, for example, the danger that infants may put the removed catch in their mouth can be avoided.

2. It is not necessary to increase the thickness of the claws of the catch base (thickness of the material) so as to increase the strength in attaching the catch, preventing an increase in material cost and production cost.

3. The weight is not increased even when the strength is increased.

4. Thin or weak cloth will not be worn even when the strength is increased.

While a specific embodiment of the invention has been shown and described in detail to illustrate the application of the principles of the invention, it will be understood that the invention may be embodied otherwise without departing from such principles.

What is claimed is:

1. A catch base for attaching a catch of a snap fastener, the catch base comprising:
six claws for attaching the catch, formed at regular intervals.

2. The catch base according to claim 1, wherein the claws are formed by punching a flat metallic sheet using a press, and are raised from the flat sheet by 90°.

3. A process for forming a catch base for attaching a catch of a snap fastener, the process comprising:
providing a flat metallic sheet;
punching said flat metallic sheet such that a catch base body and six claws are formed from said flat metallic sheet, wherein one end of each claw faces a center of said body after said flat metallic sheet has been punched;
bending each claw such that each claw is perpendicular to said catch base body.

4. A catch system, comprising:
a catch base including a catch base body and six claws, each claw being adjacent to another one of said claws, each claw being perpendicular to said catch base body;
a cloth material;
a catch element of a snap fastener located on one side of said cloth material, said catch element having catching portions, said catch base being located on another side of said cloth material, each catching portion receiving at least one of said claws, wherein each of said claws engages said catch element such that said catch base is connected to said catch element.

5. A catch system according to claim 4, wherein each claw forms a bent claw portion when each claw engages one of said catching portions, said bent claw portion extending in an outward direction, said outward direction being a direction opposite a center of said catch base body.
